(19) United States
(12) Patent Application Publication
(10) Pub. No.: US 2005/0050013 A1
(43) Pub. Date: Mar. 3, 2005

(54) System and method for policy-driven device queries

(75) Inventor: Andrew Rodney Ferlitsch, Tigard, OR (US)

Correspondence Address: Gerald W. Maliszewski;The Law Office of Gerald Maliszewski, P.O. Box 270829, San Diego, CA, 92198-2829, US

(73) Assignee: Sharp Laboratories of America, Inc.

(21) Appl. No.: 10/650,657

(22) Filed: Aug. 28, 2003

(51) Int. Cl. G06F 7/00

(52) U.S. Cl. 707/3

(57) ABSTRACT

A policy-driven system and method are provided for querying devices. The method comprises: accepting a query, from a client, directed to a device; selecting a query policy; and, sending the query to an agent using a method responsive to the selected query policy. The queries may concern a device communication port information, network information, communication checks (Ping), capability requests, or status updates. The methods may include spooler API, simple network management protocol (SNMP), printer database, proprietary protocol, Windows 2K directory service, service location protocol (SLP), and HTTP embedded device web page queries. The method further comprises: receiving a query result from the agent; and, sending the query result to the client using a method responsive to the selected query policy. In some aspects, an additional step merges a plurality of query results in response to the selected query policy. Then, the merged query result is sent to the client.

### BACKGROUND OF THE INVENTION

1. Field of the Invention

This invention generally relates to device query processes and, more particularly, a policy-driven system and method for querying local, remote, or network-connected devices.

2. Description of the Related Art

A client may be connected to other devices through either a local, network, remote connection, or a combination of these connections. For example, a printer may be connected to a personal computer (PC) through a local connection, such as a parallel port cable. Continuing this example, the PC may seek to query a printer on subjects such as the device's identification, network information, capabilities, and/or status. There are usually a variety of methods for conducting a query. For example, to check a printer's status, a query can be sent directly to the printer, or to a local spooler that is queuing jobs for the printer. The various query methods may differ in the kind of information returned, accuracy, or reliability. It is difficult to determine and pre-program a device with the optimal query method.

Conventionally, there are several methods to obtain information from a device. One method is for the host to establish a peer-peer connection with the device and directly request information from the device using a single method, such as simple network management protocol (SNMP). In this example, the host runs an application that permits the host to act as an SNMP client, while the device is treated as an SNMP agent. The application support queries of various categories, such as: port information; network information (IP address); communication, such as Ping (IP address accessibility); capabilities; and, status.

FIG. 1 is a schematic block illustrating a SNMP query (prior art). Requests for information are composed into the appropriate format for this method, such as an SNMP OID fetch. This method suffers in that: the device must support this single method and be responding; it must be possible to map the query to the method; the method implemented on the device must support the request; the result may not be reliable, depending on the method; the network traffic load and elapsed time may not be optimal, depending on the method; and, non-volatile information is not cached for duplicated requests.

FIG. 2 is a schematic block diagram illustrating a hard-coded multiple query method (prior art). In this method, the host has an application that supports multiple methods of querying the device, but the selection of methods, and how multiple responses are combined, is hard-coded. The product EZ Cluster® from Sharp Corporation is used to illustrate this method. In EZ Cluster®, the user can request a variety of information categories, such as those referenced above. For each category, EZ Cluster has a predetermined set of methods for querying the device, and a predetermined method to combine multiple responses. For example, if the user wants to know the number of jobs printing on a printer device, the host queries the local and remote spooler for jobs queued on their respective client/server, or queries the printer using SNMP for queued jobs. If a user wants to know whether the printer has duplex capability, the host queries the device using SNMP and a built-in printer database for base configuration on a per printer model. Finally, EZ Cluster® has a system of hard-coded rules for ranking the reliability of responses based on the query method. The most reliable result is then returned.

This method still suffers in that: the method may not be optimal (slow speed) for a specific device; the methods may be redundant (same reliability) for a specific device, network or host; the method for combining the responses may not be reliable for a specific device; and, non-volatile information is not cached for duplicated requests.

It would be advantageous if a host could use a query method, or plurality of methods most likely to return query results on the basis of need.

It would be advantageous if query methods could be selected in response to result-oriented criteria such as speed or accuracy.

It would be advantageous if the results to a plurality of queries could be merged.

### SUMMARY OF THE INVENTION

The present invention addresses the problem of obtaining information from one or more devices, by selectively using a plurality of query methods. More specifically, the invention further solves the problems of: selecting the set of methods to query the device(s); and, merging the responses from multiple query methods into a single result.

Accordingly, a policy-driven method is provided for querying in a system of devices. The method comprises: accepting a query, from a client, directed to a device; selecting a query policy; and, sending the query to a agent using a method responsive to the selected query policy. The queries may concern device communication port information, network information, communication checks (Ping), capability requests, or status updates. As used herein, the term “query policy” means one or more groups of query methods, where each group may include a plurality a query methods. The methods may include spooler application programming interface (API), simple network management protocol (SNMP), printer database, proprietary protocol, Windows 2K directory service, service location protocol (SLP), printer job language (PJL) USTATUS, and BMLinkS queries, as well as queries concerning an embedded device web page using hypertext transport protocol (HTTP), and other industry standard methods.

The method further comprises: receiving a query result from the agent; and, sending the query result to the client using a method responsive to the selected query policy. In some aspects, an additional step merges a plurality of query results in response to the selected query policy. Then, the merged query result is sent to the client.

In one aspect a multi-mode query policy can be selected. Then, a query is sent to a plurality of agents, and the plurality of query results are merged. Alternately, pre-configured, manually selected, or automatically selected policies can be used. In yet another aspect, an information-type query policy can be selected. Then, for each agent, a method is used that corresponds to the information requested in the query.

In one aspect, an element-type query policy is selected and the method further comprises identifying each type of agent associated with a directed query. Then, for each agent, a method is used that corresponds to the identified agent type. In other aspects, the policy is selected in response to either the query result time or reliability. If an accuracy policy is selected, the method further comprises: ranking the probable accuracy associated with each agent query method; and, sending a query to a agent using a plurality of methods. Then, the query results are merged by selecting the results most likely to be accurate.

Additional details of the above-described method and policy-driven system for querying devices are provided below.

### BRIEF DESCRIPTION OF THE DRAWINGS

FIG. 1 is a schematic block illustrating a SNMP query (prior art).

FIG. 2 is a schematic block diagram illustrating a hard-coded multiple query method (prior art).

FIG. 3 is a diagram illustrating a Discover Reuse dynamic kink library (DLL) query method.

FIG. 4 is a schematic block diagram of the present invention policy-driven system for querying devices.

FIGS. 5a through 5f are diagrams illustrating the application of exemplary policies.

FIG. 6 is a diagram illustrating the application of a global policy.

FIG. 7 is a diagram illustrating information based policy selection.

FIG. 8 is a diagram illustrating the cache aspect of the present invention system.

FIG. 9 is a flowchart illustrating the present invention policy-driven method for querying in a system of devices.

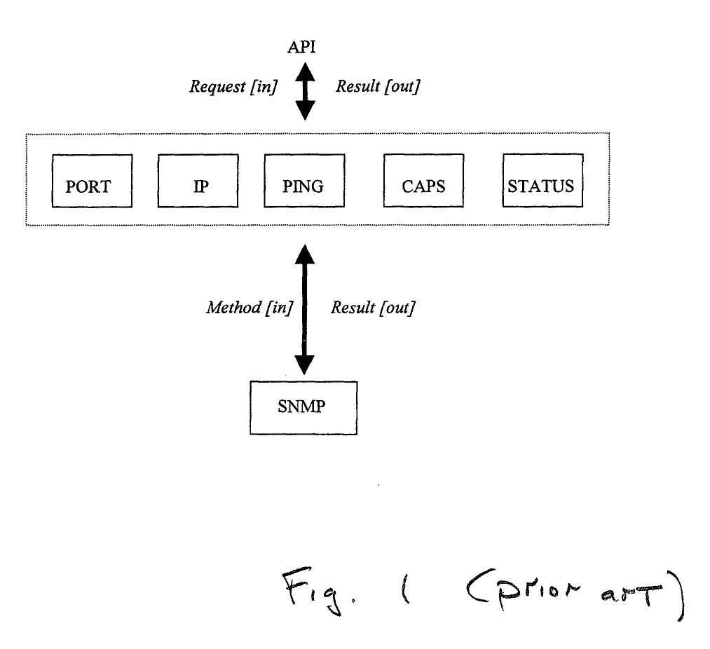

### DETAILED DESCRIPTION OF THE PREFERRED EMBODIMENTS

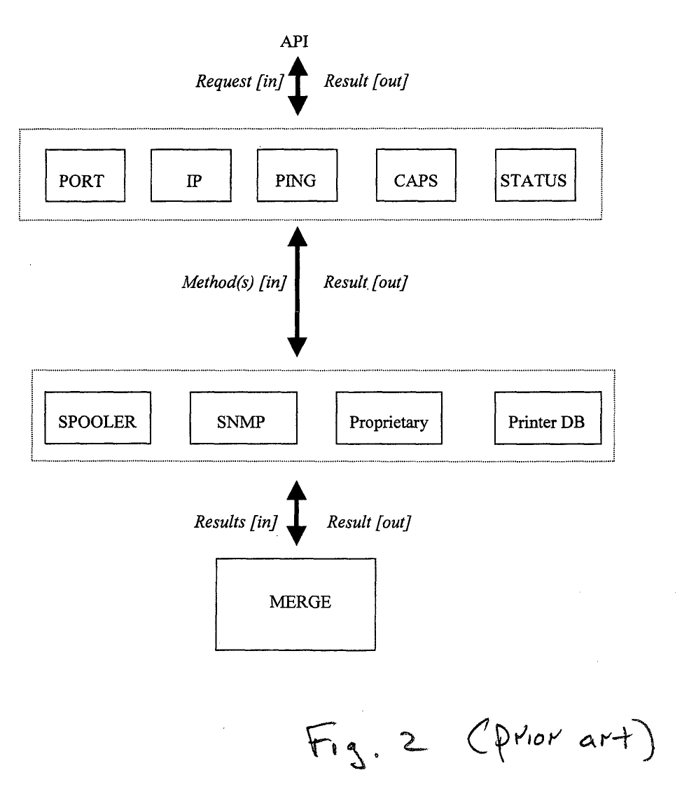

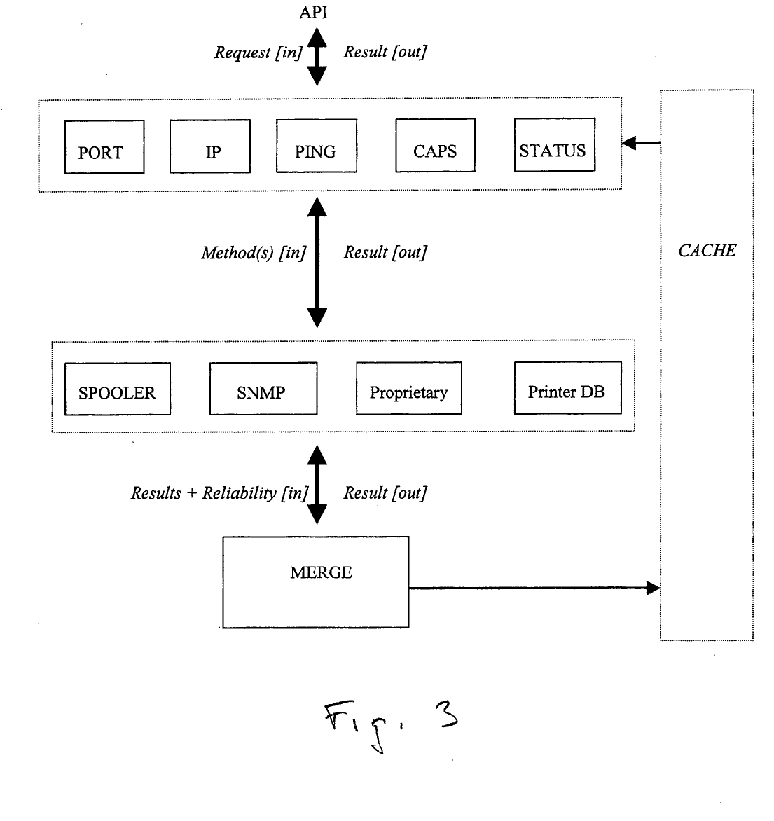

FIG. 3 is a diagram illustrating a Discover Reuse dynamic link library (DLL) query method. The Discover Reuse DLL method demonstrates an improvement over the method described by FIG. 2. The Discover Reuse DLL supports additional concepts: a cache for duplicated requests of non-volatile information, such as printer capabilities; a method to detect information in the cache that is invalidated, such as a new printer being installed or new printer options being made available; and, the response reliability determination is independent of the merge unit. For example, the rules for determining the reliability of the response are not hard-coded in the merge unit, but passed on by the method that generates the response.

This method still suffers in that: the selection of methods may not be optimal for the device or request, such as not being able to configure the selection of methods; alternate selection of methods cannot be specified if the preferred selection of methods fails to produce a result, such as error handling; and, the method for determining the reliability of a response from a specific device may not be accurate.

FIG. 4 is a schematic block diagram of the present invention policy-driven system for querying devices. The system 400 comprises a client 402 having an interface on line 404 to supply a query directed to a device. A manager 406, or host, has an interface connected to receive the query from the client on line 404 and an interface connected on line 408 to send queries. The manager 406 selects a query policy and sends the query using a method responsive to the selected query policy. Query policy folders 410a through 410n are intended to represent to plurality of available policies.

The client 402 is an element that has a relationship with the manager 406, expressed by line 404, that can be described by local, remote, or network connectivity. As used herein, a device is locally connected if it resides with the interfacing unit. If locally connected, the manager may reside in the same process as the client and line 404 represents intra-process communication, or within another process and line 404 represents inter-process communications. Network connectivity is relatively well-defined connectivity in a network, such as a local area network LAN. Remote connectivity is a relatively undefined form of network connection, perhaps involving an interface across more than one network.

The manager 406 may accept a query from the client 402 that is directed to information such as device communication port information, network information, communication checks (Ping), capability requests, or status updates. Likewise, the manager 406 sends a query results to the client 402 directed to the subject of the device communication port information, network information, communication checks (Ping), capability requests, or status updates. This is not an exhaustive list of all possible queries. A definitive list of queries is difficult to define unless particular client, device, agent, and manager details are first determined.

An agent 412 has an interface on line 408 to receive queries from the manager 406 and to send query results to the manager. In some aspects, the agent 412 has an interface on line to relay queries to a device (presented below). In alternate aspects, the agent 412 returns a query result based upon pre-configured information, or information saved in memory. The agent 412 can be the device that is the subject of the query. In that case, the agent is co-located with the device, or enjoys local connectivity with the device, as defined above. Alternately, the agent 412 may be a service embedded on a microprocessor-driver computer in communication with the device. For example, the agent 412 could be associated with a network server. In another aspect, the agent 412 is locally connected to the manager 406, for example, a local spooler.

A local spooler is an example of an agent that maynot delivery all of its queries to a printer (device) or receive query results from a printer (device). The local spooler is a process or application that de-spools jobs to the device, but otherwise communicates with the device in a limited manner. Instead, it has information about itself that indirectly pertains to the device. This indirect information may be returned as a printer (device) query result. For example, if the spooler has a local print queue with at least one job waiting to be sent to the printer (but not yet sent), the spooler can infer that the printer is (or will be) busy. This inference is made with directing a specific query to the printer.

The manager 406 sends a query to the agent 412 using a method selected from the group including spooler API, simple network management protocol (SNMP), printer database, proprietary protocol, Windows 2K directory service, service location protocol (SLP), PJL USTATUS, or BMLinkS queries. The queries may also concern an embedded device web page using hypertext transport protocol (HTTP), or may be a derived from other, unnamed, conventional industry standards. Note, this is note an exhaustive list of query methods. Again, a more complete list of methods is dependent upon the definition of particular system elements and system connections.

The manager 406 sends query results, received from the agent 412, to the client 402 using a method responsive to the selected query policy. It should be noted that the policy selected to send queries need not necessarily be the same policy used to send query results. In some aspects of the system 400, different sets of policies (not shown) are used for sending queries and query results.

A device 414 has an interface to receive queries from the agent and to supply query results to the agent on line 415. The device 414 is a device that has either a local, remote, or network connectivity, as defined above, with respect to the manager. In some aspects of the system 400, the device 414 is an imaging device, such as printer, fax, scanner, multifunctional peripheral (FP), or copier devices. However, the invention is not limited to any particular type of device.

In some circumstances, the manager 406 may send out a plurality of queries with respect to a single device. For example, with respect to a printer type device, separate inquires can be sent directly to the printer, as well as to a local spooler. In this aspect of the system 400, the manager 406 may merge a plurality of query results in response to the selected query policy, and send the merged query result to the client 402.

The manager 406 may merge query results using different processes. In one aspect, the query results may be grouped. For example, a new result may be derived from a group of results. In another aspect the query results are weighted. The selected policy may include the weighting factors. For example, SNMP methods may be given a greater weight than a spooler method. In yet another aspect, the results may be filtered or categorized. For example, if the query results concern an error state, the query result with the highest error state value may be returned to the client. Alternately, one result can be picked from a group of results.

The policies may be organized across many different types of selection criteria. It should be understood that not only are different policies selectable, but different means can also be used to make the policy selections. In one aspect, the manager 406 selects a policy in response to either pre-configured, manual, or automatic selection criteria. Pre-configured policies are policies that that are always used, or always used in response to a particular client, information type, or device, for example. Manual selection criteria may be criteria selected by a user or administrator at run-time. Automatic policy selection criteria may include static, heuristic, or adaptive policies. Static criteria reflect the current state of the system, for example. Heuristic criteria may be responsive to a past state of the system, and adaptive criteria may be responsive to changes in the system.

As mentioned above, the manager 406 may select a multi-mode query policy, which sends a query to a plurality of agents. As shown, queries are sent to agent 412 and 416. The manager receives a plurality of query results from the corresponding plurality of agents, in this example two, and merges the plurality of query results.

As another example, the manager 406 may select a global query policy that is independent of the information requested in the query. Alternately, the manager 406 selects an information-type (non-global) query policy and sends queries corresponding to the information requested in the query.

In another aspect, the manager 406 selects an element-type query policy. Then, the manager, or a related application (not shown), has the task of identifying each type of agent associated with a directed query. The manager 406 sends queries using a method corresponding to the identified agent type. For example, if agents 412 and 416 are different types of agents, the manager may send a different method of query to each.

In one aspect of the system 400, the manager 406 selects a response time policy. The manager, or a related application, ranks the probable time associated with each agent query result. Then, the manager sends the queries in a hierarchical order responsive to the probable response times. For example, the manager may send a query to agent 412, if it is determined that the result from agent 412 will return before a result from agent 416.

Alternately, the manager 406 may select a reliability policy. Then, the manager ranks the probable reliability associated with each agent query result, and sends the queries in a hierarchical order responsive to probable reliability. In another aspect, the manager 406 selects an accuracy policy, and ranks the probable accuracy associated with each agent query method. The manager 406 sends a query to a agent, such as agent 412, using a plurality of methods, and receives a plurality of results corresponding to the plurality of query methods. The manager, then, merges the plurality of query results by selecting the results most likely to be accurate.

In one aspect of the system the agent 412 includes a cache 418, or cache memory. In some instances, the manager 406 receives a cached query result from the agent 412 in response to the selected query policy. The cached result may be used if the agent is unable to communicate with the agent, or if the device information is not especially volatile. Alternately, a cached result may be used to save system resources.

In a different aspect, the agent cache 418 may include preprogrammed, or first device permanent information. The agent 412 may return first device permanent information as a query result in response to a query concerning the first device. For example, the first device may be a particular printer model and the agent may be a printer model database (PMDB). This is a database that stores data on particular printer models. It does not have a connection, or otherwise communicate, to any printer. By whatever means, the client knows the printer type. From example, the model number may be returned in a query result from a different agent. The manager passes the printer type to the PMDB in a query, and the PMDB agent returns permanent information in a query result.

In another aspect, the agent 412 may return query results that include cached non-permanent device information that may change while the device is powered up, such as the device's status. As mentioned above, the cache 418 may include information that is permanent to the device, such as the configuration from the manufacturer. In additional, the cache 418 may include semi permanent information that can only change between power ups, such as the installation of optional equipment on the device.

Semi-permanent information may be gathered at power up in response to a query to the device. Since non-permanent information may change between power up cycles, it is often useful to refresh the cache 418 during a power up cycle. The memory refresh may be carried out periodically or in response to predetermined events. The agent 412 may return a query result using permanent, semi-permanent, or non-permanent device information. Note, the storage of permanent, semi-permanent, and non-permanent information is not limited to any particular memory type.

### Functional Description

The present invention solves many of the problems associated with conventional query methods, in that the method(s) for querying the devices are independent of the information being requested. That is, the methods are not necessarily hardcoded. Caching and retrieving information from a cache can be made independent of the query method(s), as well as the information being requested. The merging of multiple results can be merged into a single result that is independent of the query methods. More than one grouping of method(s), that is a policy, may be selected for querying.

As noted above, a policy may be applied globally, for the grouping of information, or for queries directed to specific kinds of information. The policy may be configured statically, such as by a user, or dynamically, in response to changes in the system environment.

The system consists of one or more devices connected in a local, remote or network environment, and one or more client computing devices capable of requesting device information from the device. For example, a server computing device, acting as the manager or host on behalf of the client, is capable of querying a device through a device agent.

The client computing device initiates a device query, consisting of one or more bits of information, which comprises information from one or more devices. The manager application processes the query, and returns the information back to the client. A MFP or printer is recited as an exemplary device, but the invention has application to a broader class of devices.

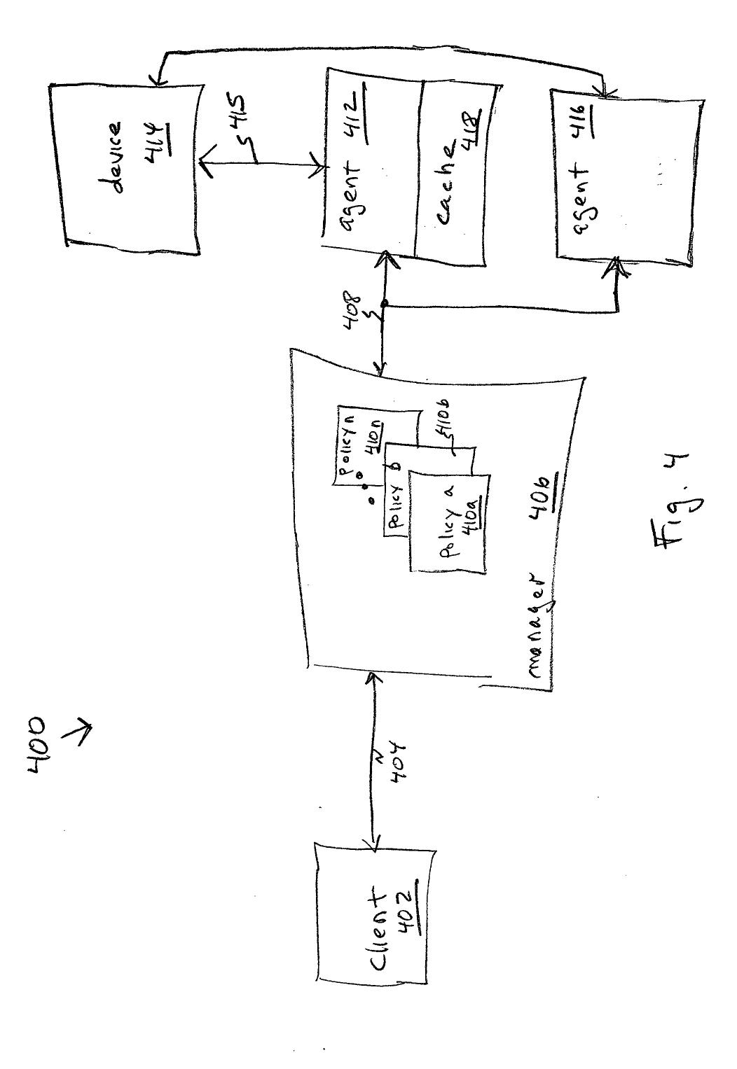

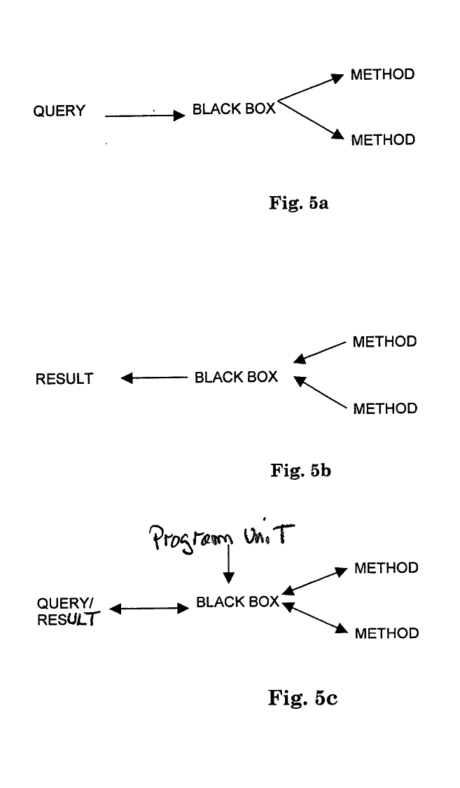

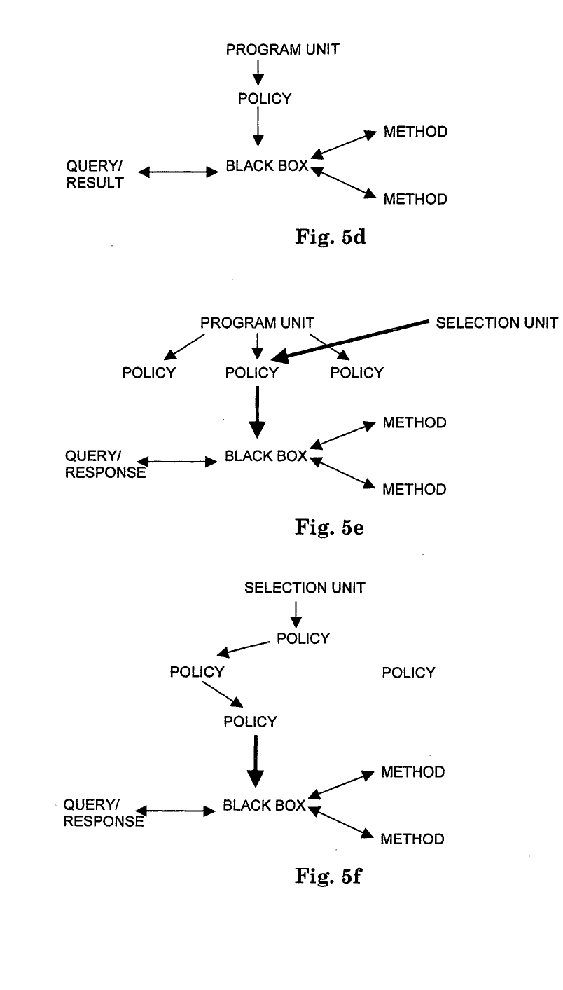

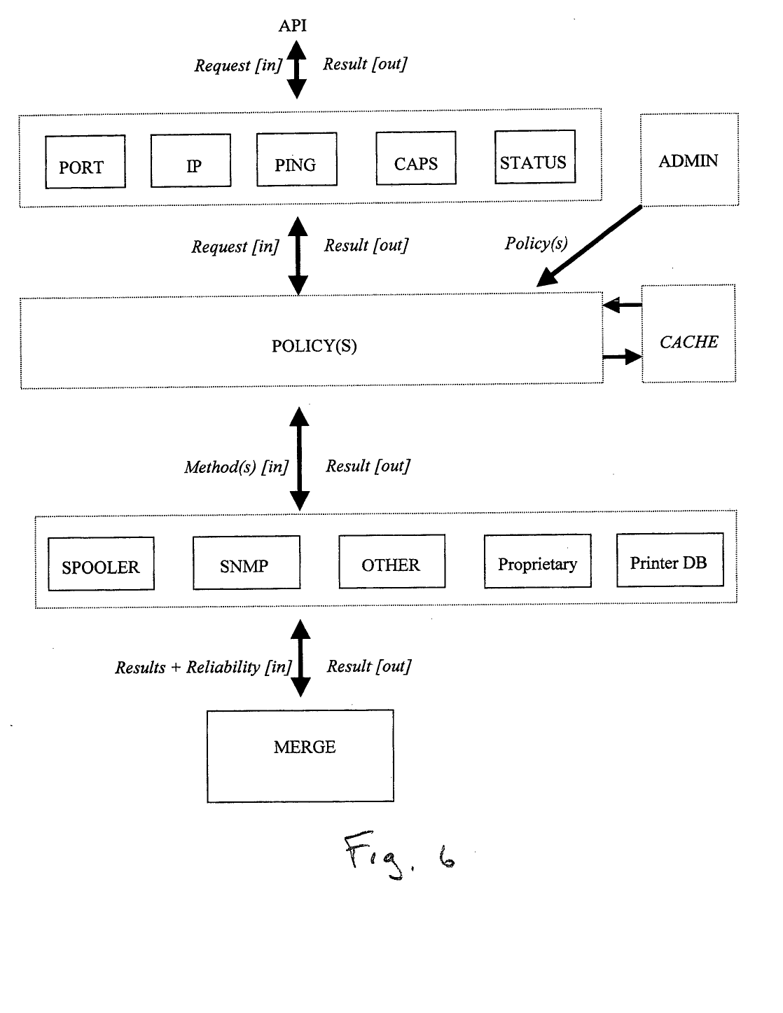

FIGS. 5a through 5f are diagrams illustrating the application of exemplary policies. The methods for querying a device are independent of the information being sought, and the selection of methods are independent of the methods, as represented by the black box (manager) in FIG. 5a.

FIG. 5b is a diagram illustrating a policy that merges multiple results from multiple methods into a single result that is independent of the query and the methods.

FIG. 5c is a diagram illustrating the aspect of programmable policy selection. The selection of methods and the merging of multiple results, in the black box (manager), can be made programmable.

FIG. 5d is a diagram illustrating additional programming aspects of the policy selection. The output of the program unit is a program that the black box (manager) uses to determine which methods are selected and how the results are merged. The program unit, which is a component of the manager, or an application in communication with the manager, may generate one or more policies. When multiple policies are defined, the application of a specific policy may be determined by a number of ways, including: pre-configuration by the user/administrator; manually specification at run-time; or, automatic selection.

In the later case, the automatic selection may be based on: static conditions—the current state of the system; heuristic conditions—the past state(s) of the system; or, adaptive conditions—in response to changes in the system as the policy is applied.

FIG. 5e is a diagram illustrating an aspect of policy selection. The specific policy can be selected from multiple policies.

FIG. 5f is a diagram illustrating an examplary relationship between policies. A policy may also be constructed as a sub-program unit. In this case, one policy may call another policy, which may call another. In one aspect, this policy calling may be programmable.

FIG. 6 is a diagram illustrating the application of a global policy. In one aspect of the invention, the policies are globally applied to the information being queried. That is, the available policies and the method for selecting a policy are independent of the information being requested.

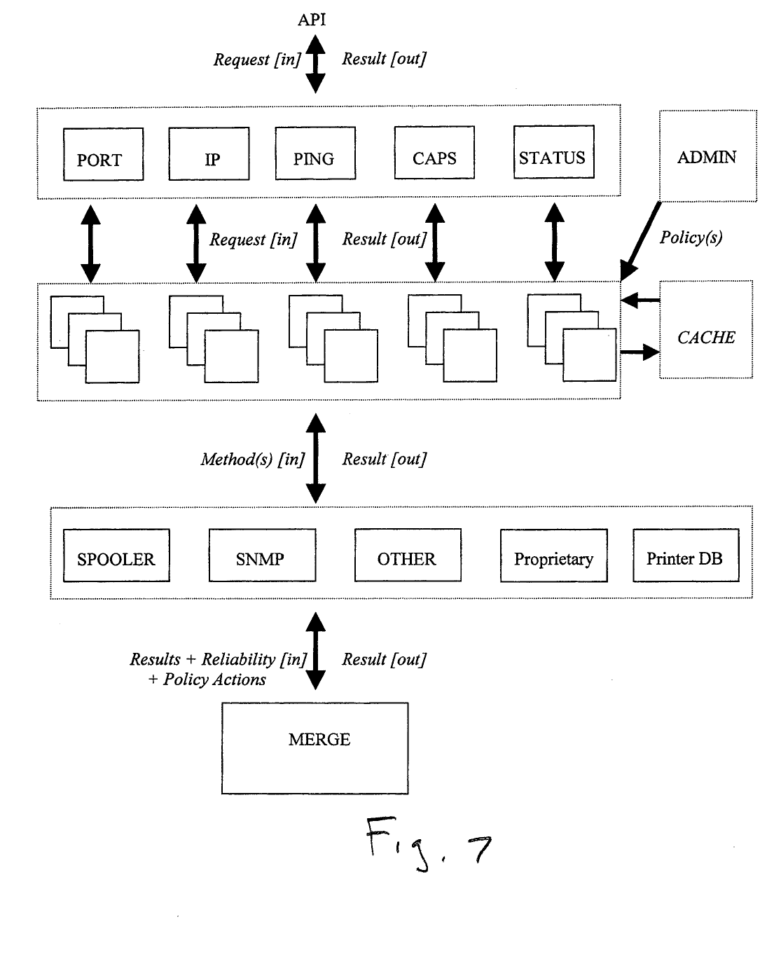

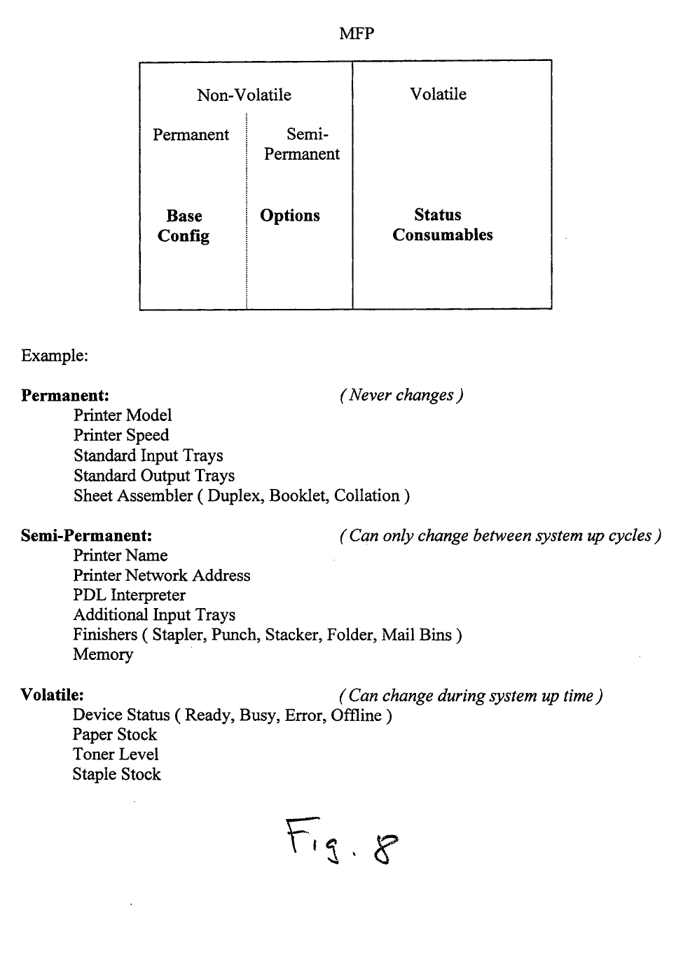

FIG. 7 is a diagram illustrating information based policy selection. In this aspect, the policies are specifically applied to the information being queried. That is, the available policies and the method for selecting a policy are dependent on the information being requested. For example, the available policies for determining whether a device is communicating may be different than the set of policies used for determining the status of a device.

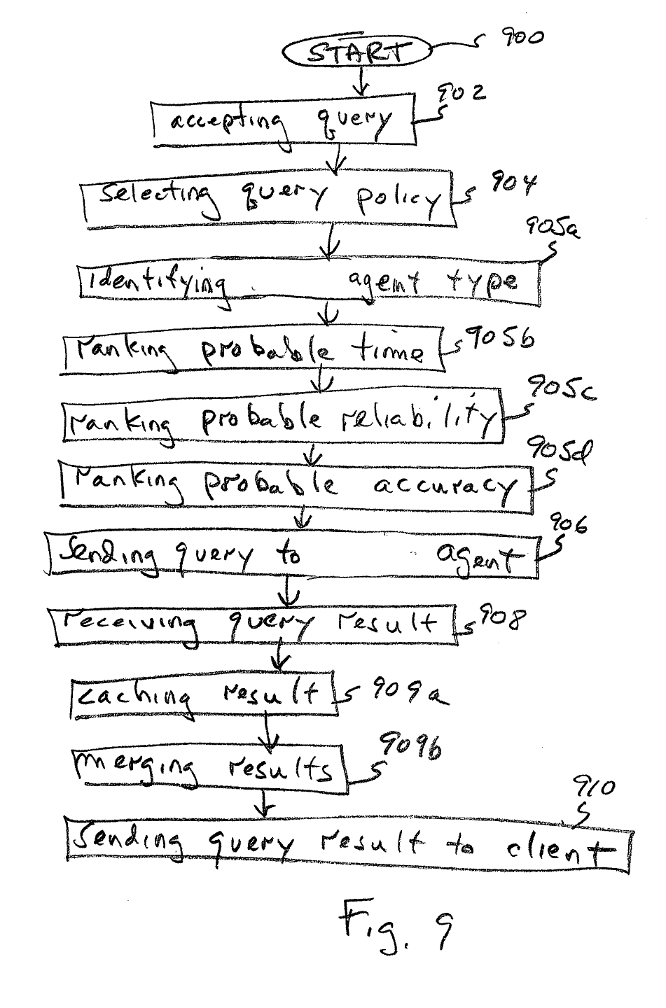

FIG. 8 is a diagram illustrating the cache aspect of the present invention system. In this aspect the performance of the system may be improved by caching results from prior queries. The cache may also be used to improve performance between multiple methods of a current query, as well as between past queries. For example, if a query asks whether a printer is communicating, as well as the printer status, the determination of communication and status can be made using separate policies. In this example, if the printer is determined to be non-communicating, the corresponding policy may cache the result. The policy that determines the status of the printer may retrieve the non-communicating state from the cache and short-circuit querying the device, sending the cached result, or an interpretation of the cached result. Note that policy for determining status may interpret a non-communicating state differently. The policy may continue to obtain status information from other sources, such as the local or remote spooler.

The refresh of cache information may be independent of the policies, driven by the policies, or both. For example, a standard method may be used to determine when to refresh information in the cache. The policy itself though may choose to override the standard algorithm and force a refresh, when a refresh would not have otherwise occurred.

Device information can be categorized as follows: Non-Volatile Permanent Data—information that does not change; Non-Volatile Semi-Permanent Data—information that does not change between power up cycles; and, Volatile Non-Permanent Data—information that can change after a power up.

Using a printer as an exemplary device, permanent data may include:
1. Device Model Name
2. Performance Specification
   a. Pages per minute in printer or scanner
   b. I/O bandwidth
   c. dots per inch (DPI) in printer or scanner
   d. Toner capacity in printer
   e. Manufacturers suggested maintenance cycle
3. Base configuration of device model
   a. Trays
      1. Input/output trays in printer
      2. Face up output trays in printer
      3. Multiple page input in scanner (document feeder, number of pages)
      4. Mix page stock in output in printer
   b. Sheet Assembly
      1. Collation in printer
      2. Copies in printer
      3. Duplex in printer or scanner
      4. Print order in printer
      5. Booklet in printer
      6. N-up in printer
   c. I/O
      1. PDL Interpreters in printer
      2. Output formats in scanner
      3. Color vs. B&W capabilities in printer or scanner
   d. Storage
      1. Hard disk capacity in printer
      2. RAM capacity in printer or scanner

Examples of semi-permanent data may include:
1. Device Name
2. Device Network Address
3. Optional configuration of device model
   a. Trays
      i. Additional input/output trays in printer
      ii. Mail bins in printer
      iii. Input capacity in printer or scanner
      iv. Output capacity in printer
   b. Finisher
      i. Staple
      ii. Saddle Stitch
      iii. Hole Punch
      iv. Fold
      v. Stack
      vi. Sorter
   c. I/O
      i. Additional PDL interpreters in printer
      ii. Forms in printer
      iii. Color matching in printer or scanner
   d. Storage
      i. additional Hard disk capacity in printer
      ii. Additional RAM capacity in printer or scanner

Examples of non-permanent data may include:
1. Device Status
   a. Idle—ready, warming up or power save
   b. Busy—printing or scanning
   c. Error—user intervention or maintenance required
   d. Offline or Non-communicating
2. Consumables
   a. Media stock in printer
   b. Toner level in printer
   c. Staple stock in printer

The division of information into the above categories is generally device dependent. For example, in one printer model the duplex unit may be standard, and in another it may be optional. Below are some methods for dividing the information into the above categories. This invention is not otherwise dependent on the method used.

Generally, device status and consumables are volatile. Base/optional configuration may be obtained from device model database, and base/optional configuration may obtained from device using a special protocol. Typical protocols for device query include: SNMP, IPP, NJR (Sharp Notify Job Return).

Non-Volatile Permanent Data from Cache

The agent, or manager acting through the agent, may query each device only once for permanent data and cache the information. The agent may elect to refresh information through a discovery protocol. Also, a plug and play method can be used, where the agent is automatically notified of the addition of a device. When a client makes a request for information, either the manager or agent may partition and categorize the request. Requests for permanent information may be obtained from the cache. Alternately, the agent may automatically or manually recheck that the same device continues to reside at the specified network address. For example, a device may be swapped out with another device. If the agent detects that a new device resides at the network address, all cached information from the device is invalidated. The agent then queries the new device for the permanent data and caches the new information.

Non-Volatile Semi-Permanent Data from Cache between Power Cycles

The agent queries each device only once per power up cycle for semi-permanent data and caches the information. Generally, the agent, or the manager acting through the agent, can either initiate the query through a periodic polling or event trap. If a device is polled, the agent looks for information that would indicate that the device was power cycled (rebooted) since the last poll. For example, if the device is SNMP enabled, the agent may retrieve, from the device's MIB, the time elapsed since the system has been enabled (sysUpTime). This timestamp can be compared with the previous timestamps, and the elapsed time used to determine if the device has been power cycled.

If the agent uses an event trap, the device can be notified that that the agent wants to receive power up events. Generally, the agent registers this event trap during the one time retrieval of permanent data. Once registered, the device sends a power cycle event message each time the device is powered cycled.

The agent additionally queries a device for semi-permanent data and caches the information, if the cached information was invalidated. When a client makes a request for information from a device, the manager partitions and categories the request. Requests for semi-permanent device information are obtained from the cache and returned back to the client.

Volatile Data fetched from Cache—Event Trap

The agent, or the manager acting through the agent, may use event traps to cache non-permanent device information. When a client makes a request for device information from a device, the agent determines if the information from this device currently is being trapped. If not, an event trap is registered with this device. The agent will then query the device to obtain the current information. If the event is already registered with the device, a query result will return the information from cache. If the event is not registered with the device, a query result will return information from the agent, or manager.

Note, for performance purposes, the agent need not register all events with all devices. Instead, optimal trapping can be established (i.e., least number of event traps) by registering only event traps that have been requested at least once before. Alternately, device event trapping may be optimized by unregistering event traps when a respective client disengages. Disengaging could include the client sending a message to the manager that it is no longer monitoring a device or event, or the manager may periodically poll the client for online status and system uptime (i.e., detect offline or reboot).Some exemplary policy examples are presented below to further illustrate the invention. It can be assumed for example, that the methods available for querying a network printer ( i.e., print queue on a network server), are: SNMP; local spooler; and, network spooler. In this methods context, some possible policy examples include: fastest response, most relaiable, most accurate, or device specific.

The fastest response policy might execute methods in a hierarchical order, from fastest to slowest result times, until a result is received, regardless of the reliability. In the above example, the local spooler would likely be queried first. If no response is received from the local spooler, the network spooler would likely be next queried. Finally, if no response is received from the network spooler, then an SNMP query would be made directly to the device.

For example, if the query is for status, the status reported by the local spooler may not be reliable. For instance, the local printer may have queued the print job for printing and reported the status as busy. In the meantime, the printer may have jammed, with this condition not being reported back to the local spooler. The reverse can also be true. The printer can be in a ready-to-print state, but the print queue on the network printer can be offline. In this case, jobs cannot be printed on the printer, if the print job is sent through the print queue. However, the job may be printed if it is sent peer-peer, depending on status of local spooler.

The most reliable policy may execute methods in hierarchical order, from most to least reliable, until a result is received, regardless of the response time. Reliability may be defined as the response that is most often correct. In this case, a SNMP query would likely be first. If no result is received, then the network spooler may next be queried. Finally, if no response is received from the network spooler, then the local spooler would be queried.

The most accurate policy might execute all the available methods and merge the results. Note, the methods may be invoked sequential or in parallel. This policy could also define a method for merging the responses into a single response that most accurately reflects the ability to print to the printer.

The element specific policy may incorporate element specific methods, where the element is defined as the agent receiving queries from the manager. For example, a standard SNMP MIB does not describe manufacturer specific options. Generally, the manufacturer provides an extended MIB, that is proprietary to that device, for this information. For a specific known device, the policy may decide to retrieve the information by a means other than the extended MIB. For example, assuming the agent and printer are the same element, each model line of digital imaging printers has a different extended MIB. To support retrieving information from the extended MIB, each of the extended MIBs has to be coded into the SNMP method. On the other hand, several model lines share a common proprietary communication protocol (Sharp NJR), that provides this same information. In this example, the policy may use the proprietary (NJR) protocol as the preferred means if the device is known to be from one of these model lines.

When multiple responses are received, the responses may be passed to a merge unit associated with the manager to produce a single result. Generally, the merge unit can either: select a single result from the group of results; or, create a new result derived from the group of results.

One method of selecting or merging a result is to weight the results. Weights might be set by the policy or by the method. For example, the SNMP method may be given a higher weight than the local spooler method. On the other hand, the policy may have reasons for assuming that the local spooler is more reliable/accurate, and give a higher weight to the local spooler result.

Another method of selecting or merging a result is by filtering or categorizing the information being queried. Such categorization may include: highest value, lowest value, and bit-wise OR. For example the highest value might be used if the responses represent error states. Then, the highest error state would be returned. The lowset value might be used if the results represent printer toner level. Then, the lowest toner level would be returned. If the results represent error states as mutually exclusive bit values, then the responses could be bit-wise OR'ed into a new value.

FIG. 9 is a flowchart illustrating the present invention policy-driven method for querying in a system of devices. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 900.

Step 902 accepts a query, from a client, directed to a device. Step 904 selects a query policy. Step 906 sends the query to a agent using a method responsive to the selected query policy. Step 908 receives a query result from the agent. Step 910 sends the query result to the client using a method responsive to the selected query policy.

Accepting a query in Step 902 and sending a query result in Step 910 include accepting a query, and sending a query result directed to information concerning device communication port information, network information, communication checks (Ping), capability requests, or status updates. Sending the query to the agent in Step 906 includes using methods such as spooler API, simple network management protocol (SNMP), printer database, proprietary protocol, Windows 2K directory service, service location protocol (SLP), PJL USTATUS, BMLinkS queries, queries concerning an embedded device web page using hypertext transport protocol (HTTP), or other industry standard methods. The present invention is not limited to any particular method, or set of methods.

Further, accepting a query in Step 902 may include accepting a query from either a local, remote, or network-connected client. In other aspects Step 902 accepts a query directed to an imaging device such as a printer, fax, scanner, MFP, or copier device.

Likewise, sending the query to a agent in Step 906 includes sending a query to a agent having either a local, remote, or network connectivity with the device. In other aspects Step 906 sends the query to a agent that is the device that is the subject of the query (the agent and device are co-located or locally connected), or to a microprocessor-driver computer including a service in communication with the device.

Some aspects of the method include a further step, Step 909a, of caching query results. Then, Step 908 may include receiving a cached query result in response to the selected query policy. Alternately, Step 902 may accept a query directed to a first device. Step 906 sends the query to an agent cache, and Step 908 receives permanent (preprogrammed) first device information query results from the agent cache. In other aspects, Step 909a caches device information in the agent cache, along with the permanent device information. The cached information can be semi-permanent information that does not change between power up cycles, and/or non-permanent data that changes, or may change between power up cycles. Then, the query result received in Step 908 may non-permanent, semi-permanent, or permanent device information.

Some aspects of the method further include Step 909b. Step 909b merges a plurality of query results in response to the selected query policy. Then, sending the query result to the client in Step 910 includes sending the merged query result to the client. Step 909b may merge query results using a process such as filtering query results, grouping a plurality of results into a single result, or weighing the plurality of results, as defined above.

In some aspects, Step 904 selects a multi-mode query policy. Then, sending the query to the agent (Step 906) includes sending a query to a plurality of agents. Receiving a query result from the agent (Step 908) includes receiving a plurality of query results from the corresponding plurality of agents. Then, Step 909b merges the plurality of query results from the plurality of agents.

In other aspect, selecting a query policy in Step 904 includes using a selection criteria such as pre-configured, manual, or automatic selection criteria, as defined in the description of FIG. 4. As noted above, there are static, heuristic, and adaptive automatic selection criteria.

In another aspect, Step 904 selects a global query policy that is independent of the information requested in the query. Alternately, Step 904 may select an information-type query policy. Then, sending the query to the plurality of agents in Step 906 includes, for each agent, uses a method corresponding to the information requested in the query. In another aspect, Step 904 selects an element-type query policy. Then, a further step, Step 905a, identifies each type of agent associated with a directed query, and Step 906, for each agent, uses the method corresponding to the identified agent type.

In one aspect of the method Step 904 selects a response time policy. Step 905b ranks the probable time associated with each agent query result, and Step 906 sends the queries in a hierarchical order responsive to the probable result times. In another aspect, Step 904 selects a reliability policy. Step 905c ranks the probable reliability associated with each agent query result, and Step 906 sends the queries in a hierarchical order responsive to probable reliability.

In one aspect Step 904 selects an accuracy policy. Step 905d ranks the probable accuracy associated with each agent query method. Sending the query to a agent in Step 906 includes sending a query to a agent using a plurality of methods. Receiving a query results from the agent in Step 908 includes receiving a plurality of results corresponding to the plurality of query methods. Then, merging a plurality of query results in Step 909b includes selecting the results most likely to be accurate. A policy-driven system and method have been presenting for directing queries, and receiving and merging query results, between a client and a device such as a printer. A few examples of devices, methods, and policies have been given to illustrate some uses of the invention, but the invention is not limited to just these examples. The invention might be incorporated in the print subsystems of the Microsoft Windows Operating System, Apple MacIntosh Operating System, Linux Operating System, System V Unix Operating Systems, BSD Unix Operating Systems, OSF Unix Operating Systems, Sun Solaris Operating Systems, HP/UX Operating Systems, or IBM Mainframe MVS Operating System. Other embodiments include device query/discovery methods such as SLP, Printer Database, installed printer configuration, device directory services, such as LDAP, and web page scraping. Other variations and embodiments will occur to those skilled in the art.

1. In a system of devices, a policy-driven method for querying, the method comprising:
accepting a query, from a client, directed to a device;
selecting a query policy; and,
sending the query to an agent using a method responsive to the selected query policy.

2. The method of claim 1 further comprising:
receiving a query result from the agent; and,
sending the query result to the client using a method responsive to the selected query policy.

3. The method of claim 2 further comprising:
merging a plurality of query results in response to the selected query policy; and,
wherein sending the query result to the client includes sending the merged query result to the client.

4. The method of claim 3 wherein selecting a query policy includes selecting a multi-mode query policy;
wherein sending the query to the agent includes sending a query to a plurality of agents;
wherein receiving a query result from the agent includes receiving a plurality of query results from the corresponding plurality of agents; and,
wherein merging a plurality of query results includes merging the plurality of query results from the plurality of agents.

5. The method of claim 2 wherein selecting a query policy includes using a selection criteria from the group including pre-configured, manual, and automatic selection criteria.

6. The method of claim 5 wherein using an automatic selection criteria includes using an automatic selection criteria from the group including static, heuristic, and adaptive criteria.

7. The method of claim 4 wherein selecting a query policy includes selecting a global query policy that is independent of the information requested in the query.

8. The method of claim 4 wherein selecting a query policy includes selecting an information-type query policy; and, wherein sending the query to the plurality of agents using a method responsive to the selected query policy includes, for each agent, using a method corresponding to the information requested in the query.

9. The method of claim 4 wherein selecting a query policy includes selecting an element-type query policy; and, the method further comprises:
identifying each type of agent associated with a directed query; and,
wherein sending the query to the plurality of agents using a method responsive to the selected query policy includes, for each agent, using the method corresponding to the identified agent type.

10. The method of claim 4 wherein selecting a query policy includes selecting a policy from the group including response time and reliability policies.

11. The method of claim 10 wherein selecting a query policy includes selecting a response time policy; and, the method comprising:
ranking the probable time associated with each agent query result; and,
wherein sending the query to the plurality of agents includes sending the queries in a hierarchical order responsive to the probable result times.

12. The method of claim 10 wherein selecting a query policy includes selecting a reliability policy; and,
the method comprising:
ranking the probable reliability associated with each agent query result; and,
wherein sending the query to the plurality of agents includes sending the queries in a hierarchical order responsive to probable reliability.

13. The method of claim 3 wherein selecting a query policy includes selecting an accuracy policy; and,
the method comprising:
ranking the probable accuracy associated with each agent query method;
wherein sending the query to an agent includes sending a query to an agent using a plurality of methods;
wherein receiving a query results from the agent includes receiving a plurality of results corresponding to the plurality of query methods; and,
wherein merging a plurality of query results includes selecting the results most likely to be accurate.

14. The method of claim 1 wherein accepting a query, from a client, directed to a device includes accepting a query directed to information concerning device communication port information, network information, communication checks (Ping), capability requests, and status updates; and,
wherein sending the query result to the client using a method responsive to the selected query policy includes sending a query result directed to information concerning device communication port information, network information, communication checks (Ping), capability requests, and status updates.

15. The method of claim 1 wherein sending the query to the agent using a method responsive to the selected query policy includes using a method selected from the group including spooler application programming interface (API), simple network management protocol (SNMP), printer database, proprietary protocol, Windows 2K directory service, service location protocol (SLP), print job language (PJL) USTATUS, BMLinkS queries, queries concerning an embedded device web page using hypertext transport protocol (HTTP), and other industry standard methods.

16. The method of claim 3 wherein merging a plurality of query results includes merging query results using a process selected from the group including filtering query results, grouping a plurality of results into a single result, and weighing the plurality of results.

17. The method of claim 1 further comprising:
caching device information; and,
wherein receiving a query result from the agent includes receiving cached device information as the query result.

18. The method of claim 1 wherein accepting a query, from a client, directed to a device includes accepting a query from a client selected from the group including local, remote, network-connected clients.

19. The method of 1 wherein sending the query to a agent using a method responsive to the selected query policy includes sending a query to an agent having a connectivity with the device selected from the group including local, remote, and network connectivity.

20. The method of claim 1 wherein accepting a query, from a client, directed to a device includes accepting a query directed to an imaging device selected from the group including a printer, fax, scanner, multifunctional peripheral (MFP), and copier devices.

21. The method of claim 1 wherein sending the query to an agent using a method responsive to the selected query policy includes sending the query to an agent selected from the group including the device that is the subject of the query and a microprocessor-driver computer including a service in communication with the device.

22. The method of claim 2 wherein accepting a query, from a client, directed to a device includes accepting a query directed to a first device;
wherein sending the query to a agent using a method responsive to the selected query policy includes sending the query to a agent cache including first device permanent information; and,
wherein receiving a query result from the agent includes receiving first device permanent information query results from the agent cache.

23. The method of claim 22 further comprising:
caching device information in the agent cache; and,
wherein receiving a query result from the agent includes receiving query results from the agent cache selected from the group including permanent and cached device information.

24. The method of claim 23 wherein caching device information in the agent cache includes caching semi-permanent information that does not change between power up cycles and non-permanent data that changes between power up cycles.

25. A policy-driven system for querying devices, the system comprising:
a client having an interface to supply a query directed to a device;
a manager having an interface connected to receive the query from the client and an interface to send queries, the manager selecting a query policy and sending the query using a method responsive to the selected query policy.

26. The system of claim 25 further comprising:
an agent having an interface to receive queries from the manager and to send query results to the manager; and,
wherein the manager sends query results, received from the agent, to the client using a method responsive to the selected query policy.

27. The system of claim 26 wherein the agent has an interface for relaying queries; and,
the method further comprising:
a device having an interface to receive queries relayed from the agent and to supply query results to the agent.

28. The system of claim 26 wherein the manager merges a plurality of query results in response to the selected query policy and sends the merged query result to the client.

29. The system of claim 28 wherein the manager selects a multi-mode query policy, sends a query to a plurality of agents, receives a plurality of query results from the corresponding plurality of agents, and merges the plurality of query results.

30. The system of claim 26 wherein the manager selects a policy in response to criteria from the group including pre-configured, manual, and automatic selection criteria.

31. The system of claim 30 wherein the manager uses an automatic policy selection criteria from the group including static, heuristic, and adaptive policies.

32. The system of claim 26 wherein the manager selects a global query policy that is independent of the information requested in the query.

33. The system of claim 26 wherein the manager selects an information-type query policy and sends queries corresponding to the information requested in the query.

34. The system of claim 26 wherein the manager selects an element-type query policy, identifies each type of agent associated with a directed query, and sends queries using a method corresponding to the identified agent type.

35. The system of claim 26 wherein the manager selects a response time policy, ranks the probable time associated with each agent query result, and sends the queries in a hierarchical order responsive to the probable result times.

36. The system of claim 26 wherein the manager selects a reliability policy, ranks the probable reliability associated with each agent query result, and sends the queries in a hierarchical order responsive to probable reliability.

37. The system of claim 28 wherein the manager selects an accuracy policy, ranks the probable accuracy associated with each agent query method, sends a query to a agent using a plurality of methods, receives a plurality of results corresponding to the plurality of query methods, and merges the plurality of query results by selecting the results most likely to be accurate.

38. The system of claim 26 wherein the manager accepts a query from the client directed to information concerning device communication port information, network information, communication checks (Ping), capability requests, and status updates, and sends a query result to the client directed to information concerning device communication port information, network information, communication checks (Ping), capability requests, and status updates.

39. The system of claim 26 wherein the manager sends a query to the agent using a method selected from the group including spooler API, simple network management protocol (SNMP), printer database, proprietary protocol, Windows 2K directory service, service location protocol (SLP), PJL USTATUS, BMLinkS queries, queries concerning an embedded device web page using hypertext transport protocol (HTTP), and other industry standards.

40. The method of claim 28 wherein the manager merges query results using a process selected from the group including filtering query results, grouping a plurality of results into a single result, and weighing the plurality of results.

41. The system of claim 26 wherein the agent includes a cache for storing device information;; and,
wherein the manager receives a cached query result from the agent in response to the selected query policy.

42. The system of claim 26 wherein the client is a device that has a relationship with the manager selected from the group including local, remote, network connectivity.

43. The system of 27 wherein the device is a device that has a relationship with the manager selected from the group including local, remote, and network connectivity.

44. The system of claim 27 wherein the device is a device selected from the group including a printer, fax, scanner, multifunctional peripheral (MFP), and copier devices.

45. The system of claim 27 wherein the agent is a device selected from the group including the device that is the subject of the query and a microprocessor-driver computer including a service in communication with the device.

46. The system of claim 26 wherein the agent includes a cache with first device permanent information and semi-permanent information, that does not change between power up cycles, the agent returning a query result from the cache in response to a query concerning the first device.

47. The system of claim 46 wherein the agent cache includes non-permanent first device information that changes between power up cycles, the agent returning a query result with device information selected from the group including permanent, semi-permanent, and non-permanent information.
